(19) United States
(12) Patent Application Publication
(10) Pub. No.: US 2013/0319201 A1
(43) Pub. Date: Dec. 5, 2013

(54) Cutting chain for cutting mineral and metal materials

(71) Applicant: ANDREAS STIHL AG & CO. KG, Waiblingen (DE)

(72) Inventor: Matthias Schulz, Freiberg (DE)

(73) Assignee: ANDREAS STIHL AG & CO. KG, Waiblingen (DE)

(21) Appl. No.: 13/650,143

(22) Filed: Oct. 12, 2012

(30) Foreign Application Priority Data
May 31, 2012 (DE) 10 2012 010 978.4

(51) Int. Cl. B23D 61/12; B28D 1/08

(52) U.S. Cl. 83/830; 125/21

(57) ABSTRACT

A cuffing chain for cutting mineral and metal materials has central chain links and lateral connecting links. The cutting chain has connecting pins with a central section which has a diameter that is greater than the diameter of openings in adjacent connecting links. The cutting chain has two connecting links which have a supporting section instead of a cutting element. At least two second connecting links positioned adjacent to one another at right angles to the direction of travel of the cutting chain are formed separately from one another. As a result, the cutting chain can be opened for maintenance and repairs despite the use of collar studs as connecting pins.

### BACKGROUND OF THE INVENTION

The invention relates to a cutting chain for cutting mineral and metal materials. The cutting chain comprises central chain links which are connected to one another by lateral connecting links, at least two connecting links being positioned adjacent to one another at right angles to the direction of travel of the cutting chain, there being provided to connect the central chain links to the connecting links connecting pins which project through first openings in the connecting links and through second openings in the central chain links, each connecting pin having a central axis, said central axes lying in a central axis plane when the cutting chain is extended, the cutting chain having at least one first connecting link to which is fixed a cutting element that has a top facing away from the connecting pin, the cutting chain having at least one second connecting link that has a supporting section instead of a cutting element.

A cutting chain for cutting mineral and metal materials comprising connecting links with cutting elements and connecting links without cutting elements is known from U.S. Pat. No. 6,186,136 B1. Connecting links which are adjacent to one another at right angles to the direction of travel are connected to one another. The connecting links which have no cutting element have a projection which slopes upwards in the direction of the next cutting element.

The object of the invention is to create a cutting chain of the generic type which has an advantageous design.

### SUMMARY OF THE INVENTION

This object is achieved by means of a cutting chain wherein the diameter of the connecting pin in a central section of the connecting pin positioned between adjacent connecting links is larger than the diameter of the first opening and wherein at least two second connecting links positioned adjacent to one another at right angles or transverse to the direction of travel of the cutting chain are designed separate from one another.

The cutting chain has connecting pins with a diameter in the central section located between adjacent connecting links is greater than the diameter of the openings in the adjacent connecting links. When manufacturing the connecting links, the distance between the adjacent connecting links can be determined with ease by means of the width of the wider diameter of the central section. Cutting elements which connect the adjacent connecting links can be retro-fitted to the connecting links. Due to the design of the connecting pins, the cutting chain cannot be opened by unriveting a connecting pin along the length of the cutting chain. This is prevented by the central section of the connecting pin. To permit easy opening and closing of the cutting chain at least two second connecting links positioned adjacent to one another in the direction of travel of the cutting chain are formed separately from one another. This means that both second connecting links can be removed from the cutting chain outwards from the connecting pin. The heads of the connecting pin on either side of the cutting chain only has to be destroyed when unriveting. In this arrangement the connecting links are designed separately, in particular when looking down on the cutting chain, and are positioned a certain distance apart. Here each second connecting link has a supporting section. This ensures that the chain runs smoothly during operation and provides good even support for the cutting chain on the workpiece.

The opening and closing of the cutting chain using the two connecting links is particularly advantage during manufacture when closing the cutting chain for the first time, when maintaining the cutting chain and for repairs. During repairs it is possible to destroy a damaged cutting element and remove the connecting link connected to this cutting element from the cutting chain. In this process the cutting element is, for example, broken off the cutting chain. The connecting links can be replaced by second connecting links with supporting sections and the chain closed again. If the height of the cutting elements on the cutting chain has been reduced by wear, the height of the supporting sections on the second connecting links is advantageously reduced accordingly, in particular by filing. A damaged drive tooth can be replaced by two connecting links by destroying the leading and trailing cutting elements, unriveting the associated connecting links, replacing the drive link and closing the cutting chain before and after the replaced drive link.

The second connecting links are advantageously flat sheet metal parts. Due to the small width of the connecting links measured at right angles to the length of the cutting chain, the top of the cutting section has a small surface area. This means that the height of the cutting sections can be reduced simply by filing.

Cutting chains for cutting mineral and metal materials are used, for example, for parting off stone, concrete and similar materials. In this process cutting chains serve primarily to cut mineral materials. However, metal embedded in stone, in particular reinforcing rods in concrete, can also be cut using this type of cutting chain.

The connecting links positioned adjacent to one another at right angles (transverse) to the direction of travel of the cutting chain are advantageously connected to one another by a common cutting element. This results in highly stable and securely fixed cutting elements. Because the cutting elements are connected to both the first connecting links positioned adjacent to one another, the connecting links cannot be removed outwards laterally by destroying the heads of the connecting pins. This is prevented by the cutting element. In particular, it is therefore advantageous in this type of cutting chain for the second connecting links to be designed separately. All connecting links are advantageously either first connecting links or second connecting links. Exactly two second connecting links can be provided. The cutting chain can be opened and closed at these two second connecting links. However, a plurality of second connecting links are advantageously provided. In particular, at least one third of the connecting links are second connecting links. The provision of a larger number of first connecting links than second connecting links makes the cutting chain more cost effective. The second connecting links and the first connecting links are advantageously arranged in a regular sequence. In particular, at least half of the connecting links are second connecting links. The number of second connecting links can also be higher than that of first connecting links.

The contour of the top of the supporting section seen in the direction of the central axis of a connecting pin is advantageously the same as the contour of the top of a cutting element seen in the direction of the central axis of a connecting pin with the result that the cutting chain is well supported on the supporting sections. The fact that the contours of the supporting sections and cutting elements are the same enables the cutting chain to run evenly. In this arrangement the top of the cutting element advantageously runs in a convex curve in the direction of travel of the cutting chain. In particular, both the tops of the cutting elements and the tops of the supporting sections run in a convex curve in the direction of travel of the cutting chain. In this manner impacts between the workpiece and the cutting elements and supporting sections are minimised and damage to the cutting elements is prevented. Such impacts to the cutting elements occur in particular when cutting reinforcing rods in stone or concrete.

The area of the top of the cutting element furthest from the central axis plane is located a first distance from the central axis plane. This first distance is thus the largest distance from the top of the cutting element to the central axis plane. In order to achieve a better cutting performance with the cutting chain running smoothly, the area of the supporting section furthest from the central axis plane is located a second distance from the central axis plane which is at least approximately 50% of the first distance. This second distance is advantageously at least approximately 80% and in particular at least approximately 85% of the first distance. The second distance is advantageously smaller than the first distance. The first and second distances can however be the same.

Advantageously, the supporting section has a first length measured in the direction of travel of the cutting chain and the cutting element has a second length measured in the direction of travel of the cutting chain, the first length being approximately 50% and advantageously at least approximately 70% of the second length. The first and second lengths are preferably approximately of equal length.

At least one central chain link and in particular every central chain link advantageously has a projection. It has proved possible to reduce vibrations during operation by the arrangement of a projection on at least one central chain link and in particular on all central chain links. Arranging a projection on each central chain link and designing the guide sections with a contour the same as the contour of the cutting elements presupposes that the cutting chain has an even outer contour. This reduces the amount of vibration created during operation. The area of the top of the projection furthest from the central axis plane is located a third distance from the central axis plane which is smaller than the first distance. This reduces wear at the projection during operation. In this arrangement the third distance is in particular smaller than the second distance from the guide section to the central axis plane. The third distance at the projection is advantageously the same as the distance from a leading or trailing edge of the top of the cutting element to the central axis plane.

At least one drive link advantageously has a guide to engage in a guide groove in a guide bar. The area of the guide furthest from the central axis plane is located a fourth distance from the central axis plane which is at least approximately 90% of a fifth distance between the area of the drive tooth furthest from the central axis plane and the central axis plane. The fact that not all drive links have a drive tooth means that the chain sprocket and/or a sprocket nose on the guide bar of a stone cutter can be designed so as to prevent a saw chain in which there is a drive tooth on each drive link from engaging. This prevents a chain which is not intended for the stone cutter from being fitted to the stone cutter and prevents the stone cutter from being operated when an unsuitable chain is fitted. In this arrangement the fourth distance is advantageously no more than 80% of the fifth distance and in particular more than 50% of the fifth distance.

### BRIEF DESCRIPTION OF THE DRAWINGS

Embodiments of the invention are explained below with reference to the drawings.

FIG. 1 shows a side view of a stone cutter.

FIG. 2 shows an exploded view of the area of the chain sprocket and the chain sprocket cover of the stone cutter illustrated in FIG. 1.

FIG. 3 shows a schematic section through the chain sprocket with the cutting chain fitted.

FIG. 4 shows a section through the sprocket nose on the guide bar with the cutting chain fitted.

FIG. 5 shows a perspective view of section of the cutting chain of the stone cutter.

FIG. 6 shows a side view of the section of the cutting chain illustrated in FIG. 5.

FIG. 7 shows a side view in the direction of the arrow VII indicated in FIG. 6.

FIG. 8 shows a perspective section of a connecting pin on the cutting chain illustrated in FIG. 6.

FIG. 9 shows a side view of the sectional plane indicated in FIG. 8.

FIG. 10 shows a perspective view of a connecting link in the cutting chain illustrated in FIGS. 5 to 9.

FIG. 11 shows a side view of the connecting link illustrated in FIG. 10.

FIG. 12 shows another side view of the connecting link illustrated in FIG. 10.

FIG. 13 shows a perspective view of a cutting element on the cutting chain illustrated in FIGS. 5 to 9.

FIG. 14 shows a perspective view of a connecting pin on the cutting chain illustrated FIGS. 5 to 9.

FIG. 15 shows a side view of the connecting pin illustrated in FIG. 14.

FIG. 16 shows a perspective view of a further connecting link in the cutting chain illustrated in FIGS. 5 to 9.

FIG. 17 shows a side view of the connecting link illustrated in FIG. 16.

FIG. 18 shows another side view of the connecting link illustrated in FIG. 16.

FIG. 19 shows a perspective view of a drive link in the cutting chain illustrated in FIGS. 5 to 9.

FIG. 20 shows a side view of the drive link illustrated in FIG. 22.

FIG. 21 shows another side view of the drive link illustrated in FIG. 22.

FIG. 22 shows a perspective view of a further drive link in the cutting chain illustrated in FIGS. 5 to 9.

FIG. 23 shows a side view of the drive link illustrated in FIG. 22.

FIG. 24 shows a perspective view of an embodiment of a cutting chain. FIG. 25 shows a side view of the cutting chain illustrated in FIG. 24.

FIG. 26 shows a side view in the direction of the arrow XXVI indicated in FIG. 25.

FIG. 27 shows a perspective view of a further embodiment of a cutting chain.

FIG. 28 shows a side view of the cutting chain illustrated in FIG. 27. FIG. 29 shows a side view in the direction of the arrow XXIX indicated in FIG. 28.

FIG. 30 shows a side view of a further embodiment of a cutting chain.

### DESCRIPTION OF PREFERRED EMBODIMENTS

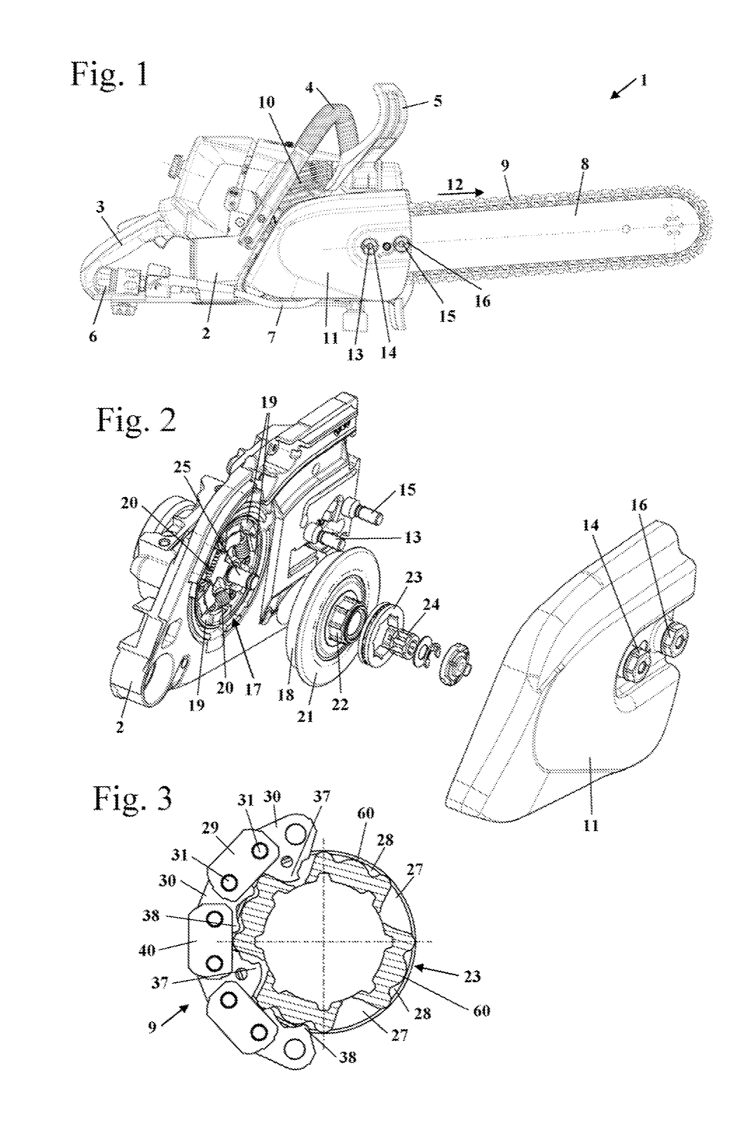

FIG. 1 shows a stone cutter 1 used for cutting mineral and metal materials such as concrete, for example. The stone cutter 1 has a housing 2 to which are fixed a rear handle 3 and a handlebar 4 for guiding the stone cutter 1 during operation. Fixed to the housing 2 is a guide bar 8 which projects forwards on the side of the housing 2 opposite the rear handle 3. Fitted around the circumference of the guide bar 8 is a cutting chain 9 which is driven around the guide bar 8 in a direction of travel 12 by a drive motor 10 positioned in the housing 2. In the embodiment the drive motor 10 takes the form of an internal combustion engine, in particular a two-stroke single cylinder engine. However, the drive motor may also be a four-stroke engine. The drive motor may also advantageously be an electric motor which is supplied with power by an electric cable or accumulator. A hand guard 5 which extends along the side of the handlebar 4 facing the guide bar 8 is fixed to the housing 2.

During operation fine grit is produced during the cutting of mineral materials such as concrete, etc. It is possible for metal to be embedded in the mineral material and to be cut through at the same time. In order to bind the grit produced during cutting and to minimise the generation of dust, the stone cutter 1 has a water connection 6 for the connection of a water supply. Water is fed to the cutting chain 9 via the water connection 6 and a water pipe 7. The water can advantageously be fed to the cutting chain 9 via channels formed in the guide bar 8.

The end of the guide bar 8 fixed to the housing 2 is covered by a chain sprocket cover 11. The chain sprocket cover 11 is placed on a first fixing bolt 13 and a second fixing bolt 15 on the housing 2 and fixed to the housing by a first fixing nut 14 and a second fixing nut 16.

FIG. 2 shows the drive of the cutting chain 9 in detail. The drive motor 10 drives a drive shaft 25 such that it rotates. If the drive motor 10 takes the form of an internal combustion engine, the drive shaft 25 is advantageously a crankshaft of the internal combustion engine. A centrifugal clutch 17 is arranged on the drive shaft 25. Flyweights 19 are connected to the drive shaft 25 such that they are unable to rotate. The flyweights 19 are pre-tensioned radially inwards by means of springs 20. If the speed of the drive shaft 25 exceeds a predetermined design speed, the flyweights 19 move outwards and come into contact with a clutch drum 18. The clutch drum 18 is thus connected to the drive shaft 25 in such a manner that it is unable to rotate. The clutch drum 18 is mounted on the drive shaft 25 by means of a bearing 35 such that it is able to rotate. The clutch drum 18 is covered towards the outside of the housing 2 by a covering plate 21. The covering plate 21 prevents dirt, in particular mud formed from water and grit in the chain sprocket area from penetrating the housing 2 and the area of the centrifugal clutch 17. The clutch drum 18 has a pinion 22 which is connected by means of splined toothing such that it is unable to rotate to a chain sprocket 23. This chain sprocket 23 drives the cutting chain 9. Alternatively, the pinion 22 can designed to drive the cutting chain 9 itself. The area of the chain sprocket 23 is covered by the chain sprocket cover 11.

FIG. 3 shows a section through a section of the cutting chain 9 as it runs around the chain sprocket 23. Only part of the cutting chain 9 is shown. The cutting chain 9 has central drive links 30 which are connected to lateral connecting links 29 and 40 by means of connecting pins 31. The structure of the connecting links 29 and 40 is described in greater detail below. Some of the drive links 30 have drive teeth 37 which engage in first recesses 27 in the chain sprocket 23. In this arrangement the drive teeth 37 engage comparatively deeply in the chain sprocket 23 and are thus entrained by the chain sprocket 23. The cutting chain 9 is driven by the drive teeth 37. In the embodiment each second drive link 30 along the length of the cutting chain 9 has a guide 38 instead of a drive tooth 37. The guide 38 engages only slightly in the chain sprocket 23, namely into one of the second recesses 28. The second recesses 28 have a central blocking section 60 which projects between two sections of the guide 38. The blocking section 60 is configured such that the drive teeth 45 are unable to engage in the second recesses 28. It is therefore impossible to fit a cutting chain in which each drive link 30 has a drive tooth 37 onto the chain sprocket 23. This reliably prevents the use of a cutting chain 9 not intended for the stone cutter 1.

In the embodiment guides 38 and drive teeth 37 are provided alternately along the cutting chain 9. A different configuration of drive teeth 37 and guides 38 matched to a different configuration of recesses 27 and 28 on the chain sprocket 23 can be provided. The guides 39 can also be eliminated completely or be designed such that they do not engage in the chain sprocket 23. To ensure better lateral guidance of the cutting chain 9 around the chain sprocket 23 the guide 38 can also be made larger and engage further in the chain sprocket 23. In such a case the outer contour of the guide 38 is advantageously designed such that a drive tooth 37 is unable to engage in a second recess 28 for a guide 38. This can be achieved by altering its shape appropriately.

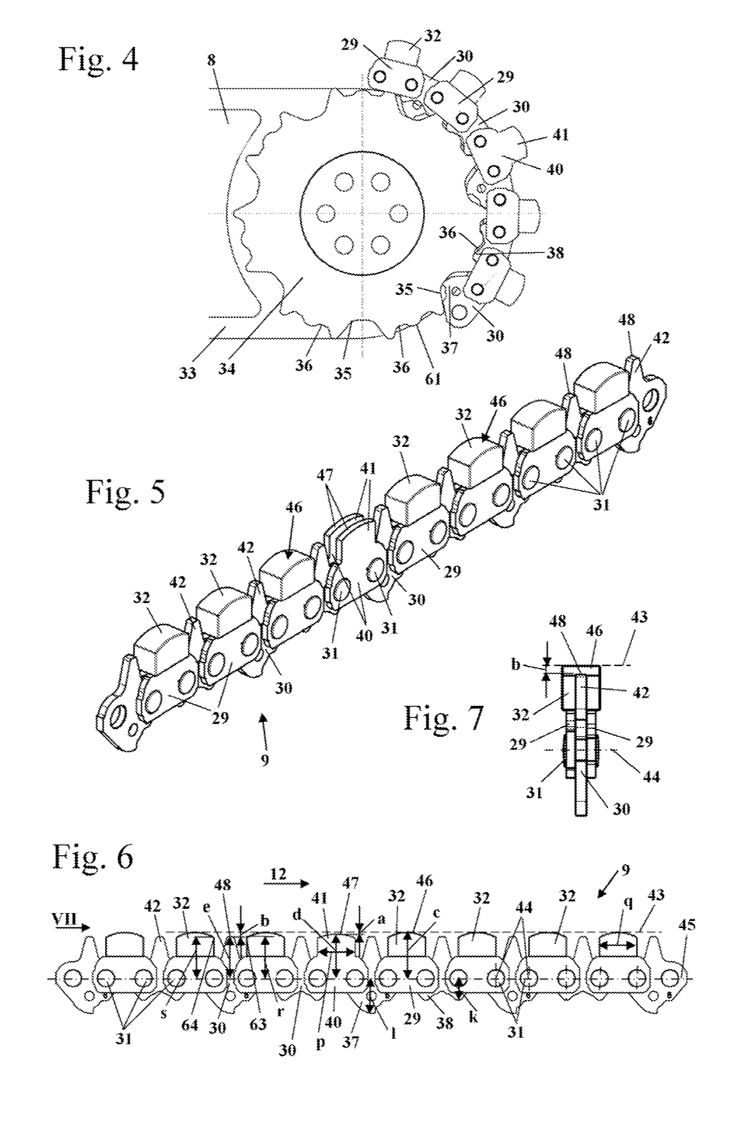

At the end of the guide bar 8 facing away from the chain sprocket cover 11 is a sprocket nose 34 which is shown schematically in section in FIG. 4. The sprocket nose 34 is mounted on the guide bar 8 such that it is able to rotate. The sprocket nose 34 has first recesses 35 in which the drive teeth 37 on the drive links 30 are able to engage. The sprocket nose 34 also has second recesses 36 in which guides 38 engage. Drive teeth 37 are unable to engage in the second recesses 36. A central blocking section 61 of the recesses 36 prevents a drive tooth 37 from engaging in a second recess 36.

In the embodiment both the chain sprocket 23 and the sprocket nose 34 have second recesses 28, 36 which form a blocking contour 60, 61 for the drive teeth 37. However, it is also possible for only the sprocket nose 34 or only the chain sprocket 23 to have second recesses 28, 36 and thus for either the chain sprocket 23 only or the sprocket nose 34 only to have second recesses 27, 35.

FIG. 5 shows the configuration of the cutting chain 9 in detail. The cutting chain 9 is made up of lateral connecting links 29 which are connected to central drive links 30 by connecting pins. In the embodiment connecting links 29 are positioned in pairs adjacent to one another with the drive links 30 engaging between them. Each pair of adjacent connecting links 29 are connecting together by a common cutting element 32. The cutting element 32 is connected fast to both connecting links 29 and bridges the drive links 30 which project between the connecting links 29. In FIG. 5 the rear connecting links are concealed. The arrangement of two connecting links 29 adjacent to one another is visible in FIG. 7.

As shown in FIG. 5, the cutting chain 9 has two second connecting links 40 positioned adjacent to one another. Instead of a cutting element 32, the two connecting links 40 each have a supporting section 41 The two connecting links 40 are formed separately from one another. In the embodiment both second connecting links 40 are designed as flat sheet metal parts. The connecting links 40 can be removed outwards by destroying the connecting pins 31 positioned on the connecting links 40 on either side of the cutting chain 9 to open the cutting chain 9.

As also shown in FIG. 5, the cutting elements 32 each have a convexly curved top 46. The supporting sections 41 have a top 47 which is also convexly curved. As shown in FIGS. 5 and 6, the contour of the tops 47 of the supporting sections 41 is the same as the contour of the tops 46 of the cutting elements 32. In this arrangement the contour of the supporting sections 41 seen at right angles to the cutting chain 9 and the contour of the cutting elements 32 seen in the same direction is also the same.

As shown in FIG. 6, each connecting pin 31 has a central axis 44. Here the contours of the tops 46, 47 of the supporting sections 41 and the cutting elements 32 and the contours of the entire supporting sections 41 and cutting elements 32 are the same seen in the direction of the central axes 44. In the interests of greater clarity, some of the elements of the cutting chain are omitted in the drawings as their arrangement is repetitive. The cutting chain 9 has only first connecting links 29 and second connecting links 40. When the cutting chain 9 is extended as shown in FIG. 6, the central axes 44 lie in a central axis plane 45. The tops 46 are located a distance c from the central axis plane 45. In this arrangement distance c is the greatest distance between the top 46 of a cutting element 32 and the central axis plane 45. Distance c is measured in the area of the top 46 which is furthest from the central axis plane 45. The areas of the tops 46 furthest away from the central axis plane 45 define a top plane 43. As shown in FIG. 6, all the elements of the cutting chain 9 lie on the side of the top plane 43 on which the central axis plane 45 is also located. No section of the cutting chain projects beyond the top plane 43. The two tops 47 of the supporting sections 41, which in the side view shown in FIG. 5 are congruent with one another, are located a distance a from the top plane 32. The distance a is advantageously very small and is, for example, less than 2 mm and in particular less than 1 mm. Distance a can also be zero. In the area in which the top 47 is furthest from the central axis plane 45, it is located a distance d from the central axis plane 45. Distance d is somewhat smaller than the distance c from the top 46 to the central axis plane 45. Distance d is advantageously at least 50% of distance c. Distance d is in particular at least approximately 75% of distance c. However, distance d is advantageously less than distance c and in particular less than 95% of distance c.

The cutting elements 32 have a length q measured in the direction of travel 12. The supporting section 41 has a length p, also measured in the direction of travel, which is at least approximately 50% and in particular at least approximately 70% of length q of the cutting elements 32. Lengths p and q of the cutting elements 32 and supporting sections 31 are advantageously the same.

As shown in FIG. 6, all drive links 60 have a projection 42 which extends towards the top plane 43. These projections 42 are shaped approximately like a truncated upward-pointing arrow. The truncated point of the arrow formed by the projection 42 forms the top 48 of the projection 42. The top 48 is a distance b from the top plane 43 which is greater than the distance a between the supporting section 41 and the top plane 43. Distance b is also shown in FIG. 7. Distance b is advantageously 1.5 to 2.5 times distance a The area of the top 48 furthest from the central axis plane 45 is a distance e from the central axis plane 45. Distance e is smaller than the distance c between the top 46 and the central axis plane 45. Distance e is also smaller than the distance d between the top 47 and the central axis plane 45. Each cutting element 32 has a leading upper edge 63 in the direction of travel 12 and a trailing upper edge 64 in the direction of travel 12. The leading upper edge 63 is a distance r from the central axis plane 45 and the trailing upper edge 64 is a distance s from the central axis plane 45. Distances e, r and s are advantageously approximately the same in order to ensure that the cutting chain 9 runs smoothly, that the top 48 of the projection 42 is sufficiently long in the direction of travel 12 and that the cutting chain 9 has sufficient mobility.

FIG. 6 also shows the configuration of the drive teeth 37 and the guides 38. The area of the drive teeth 37 furthest away from the central axis plane 45 is a distance I from the central axis plane 45. The area of the guides 38 furthest away from the central axis plane 45 is a distance k from the central axis plane 45 Distance k is advantageously no more than 90% of distance I. In particular, distance k is no more than 80% of distance I. In this arrangement distance k is advantageously more than 50% of distance I. In the embodiment distance k is approximately 60% to approximately 70% of distance I.

The cutting chain 9 has exactly two second connecting links 40 which are positioned adjacent to one another at right angles to the direction of travel 12. All the other connecting links in the cutting chain 9 are first connecting links 29. The two connecting links 40 are connected together by the same two connecting pins 31. These two connecting pins 31 can be destroyed and the connecting links 40 removed outwards from the connecting pins 31 for repair and maintenance. During manufacture or after repair an open cutting chain 9 can be closed again with connecting links 40.

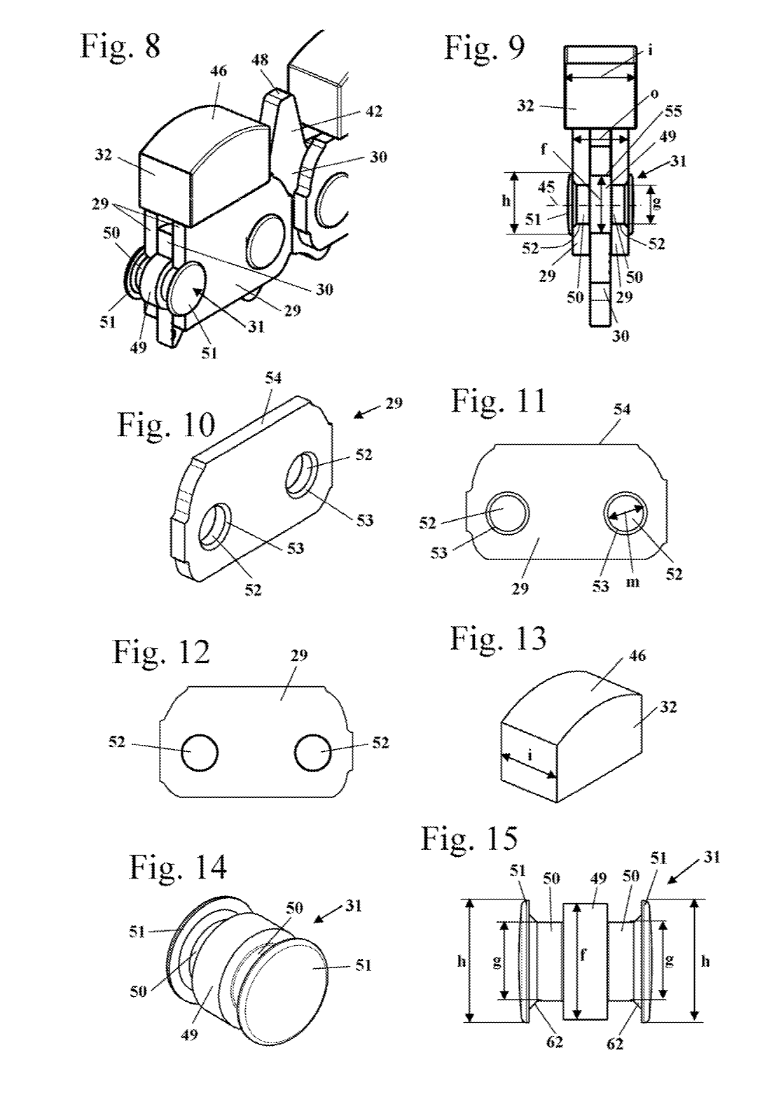

FIGS. 8 and 9 show the configuration of the connecting pins in detail. The connecting pins 31 are designed as collar studs and have a central section 49 of wider diameter. On their end faces the connecting pins 31 have heads 51 which hold the connecting links 29, 40 to the connecting links 31. A lateral section 50 which projects through the connecting links 29/40 projects between the central section 49 and the head 51 of each connecting pin 31.

As shown by the side view in FIG. 9, the central section 49 is located in the drive tooth 30. In this arrangement the central section 49 projects through the opening 55 in the drive link 30 shown in FIGS. 19 to 22. As shown in FIG. 15, the central section 49 has a diameter f. Diameter f is slightly smaller than a diameter n of an opening 55 (FIGS. 20 to 23). Diameter f can be the same or slightly larger than diameter n so that the connecting pins 31 are held in the opening 55 such that they are unable to rotate or are pressed into the opening 55. As shown in FIGS. 22 and 23 the drive links 30, which have only a guide 38 instead of a drive tooth 37, also have two openings 55 with diameters n.

As shown in FIG. 9, the lateral sections 50 of the connecting pins 31 project through openings 52 in the connecting links 29. The lateral sections 50 have a diameter g which is advantageously slightly smaller than a diameter m (FIGS. 11 and 17) of an opening 52 in a connecting link 29, 40. Diameter m of the openings 52 is clearly smaller than diameter f of the central section 49. Thus the connecting pin 31 cannot be pushed through the connecting link 29 from one longitudinal side of the cutting chain 9 to the other longitudinal side, thereby destroying at least one head 51. It is not possible to remove the connecting pin 31 along its central axis 44 (FIG. 6). The design of the connecting pins 31 as collar studs with a thicker central section ensures that the drive links 30 are well mounted. A drive link 30 is prevented from being caught between two adjacent connecting links 29, 40 by the design of the connecting pins 31 as collar studs. This results in a good mounting of the connecting links 29, 40 which are positioned adjacent to the central section 49.

As shown in FIGS. 9 and 15, the heads 51 of the connecting pins 31 have a diameter h which is clearly larger than the external diameter g in the lateral section 50. In the embodiment diameter h is also slightly larger than diameter f in the central section 49. However, diameter h can also be smaller than diameter f. The heads 51 of the connecting pins 31 secure the connecting links 29, 40 to the connecting pins 31. The diameter g is advantageously at least as big as diameter m of the openings 52 such that the connecting pin 31 is held in an opening 52 in a connecting links 29, 40 such that it is unable to rotate.

As shown in FIG. 14, the connecting pin 31 is formed as once piece. The heads 51 of the connecting pin 31 are formed after assembly of the drive link 30 and the connecting links 29 or 40, namely by rolling.

As shown in FIGS. 9 and 13 the cutting element 32 has a width i measured parallel to the central axis plane 45 which is somewhat larger than the distance o between the outward facing sides of adjacent connecting links 29. As a result the cutting element 32 projects beyond the outsides of the connecting links 29 on both sides. This ensures that the outsides of the connecting links 29 and advantageously the heads 51 of the connecting pin 31 cannot come into contact with the workpiece during operation. Thus material is removed from the workpiece by the top 46 of the cutting element 32. The cutting element 32 is block-shaped, approximately cuboid with a rounded top 47. The cutting element 32 is designed as a grinding segment and contains diamond particles embedded in a metal matrix. Each cutting element 32 is fixed and in particular welded to two adjacent first connecting links 29.

As shown in FIGS. 10 to 12, the connecting links 29 have two openings 52 each with a bevel 53 on the side facing the heads 51 of the connecting pin 31. The course of the bevel 53 is the same as the course of the bevels 62 on the sides of the lateral sections 50 of the connecting pin 31 facing the heads 51 shown in FIG. 15. As shown in FIG. 12, the sides of the connecting links 29 facing the drive link 30 are essentially flat. FIGS. 10 and 11 also show the top 54 of the connecting links 29 to which the cutting element 32 is fixed as shown in FIG. 9.

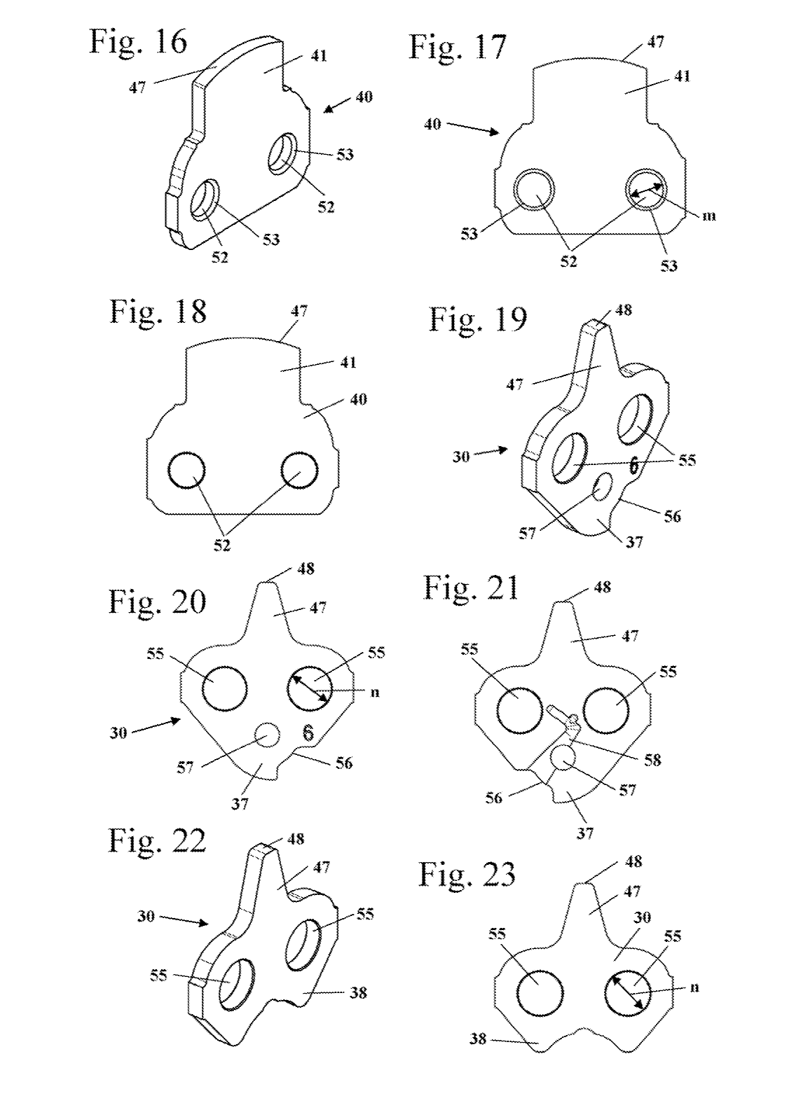

As shown in FIGS. 16 and 17, the connecting links 40 also have openings 52 with a diameter m and with a bevel 53 on the outward facing side. As shown in FIGS. 17 and 18, the top 47 has a convexly curved contour which is the same as the contour of the top 46 of the cutting element 32 (FIGS. 6 and 13). In this arrangement the contour of the supporting section 41 is the same as the contour of a cutting element 32.

As shown in FIGS. 19 to 21, the drive tooth 37 of a drive link 30 has an opening 57. The opening 57 passes through a channel 58 on one side of the drive link 30 which serves to receive and distribute liquid carried in a guide groove 33 in the guide bar 8 and thus provides for good lubrication and cooling at the drive links 30. On its forward facing side in the direction of travel 12 the drive tooth 37 has a recess which also serves to receive the liquid in the guide groove 33. The channel 58 flows into the recess 56.

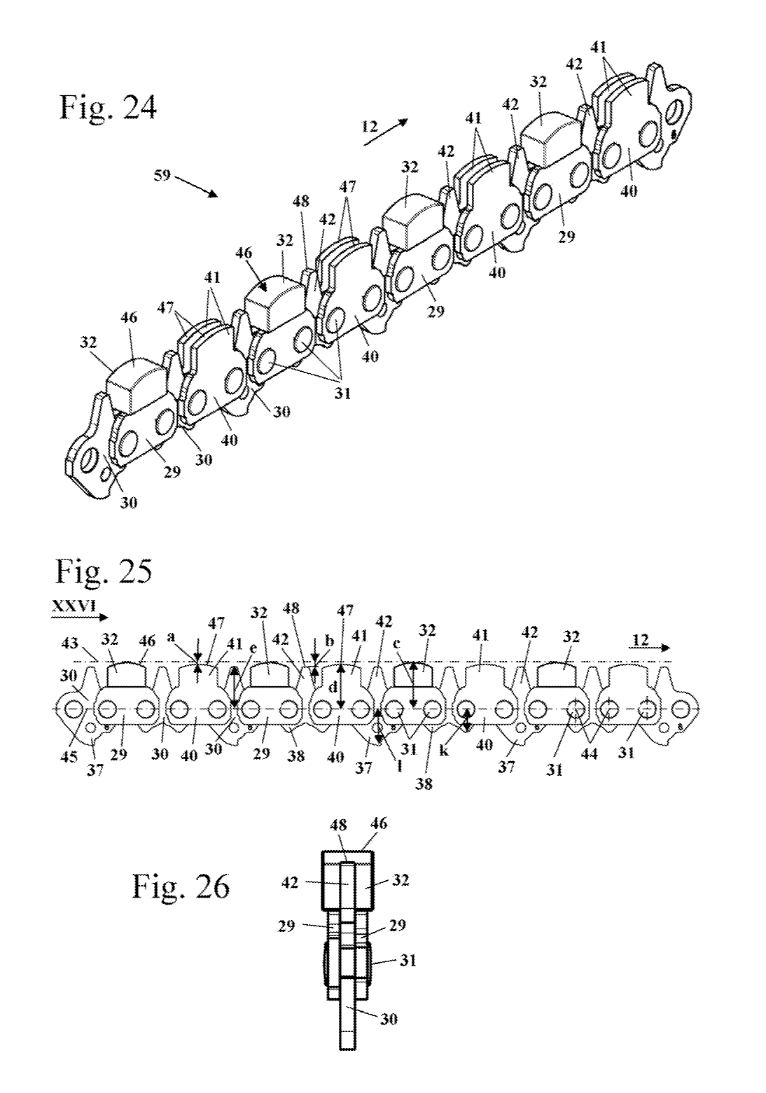

In the embodiment of a cutting chain 59 shown in FIGS. 24 to 26 the number of connecting links 40 is increased. Every second connecting link in the direction of travel is designed as a connecting link 40. First connecting links 29 which carry a cutting element 32 and second connecting links 40 which have a supporting section 41 alternate in the direction of travel. A projection 42 formed on a connecting link 40 projects upwards between each connecting section 41 and cutting element 32. As shown in FIG. 25, the tops 47 of the supporting sections 41, the tops 46 of the cutting elements 32, the tops 48 of the projections 42 and the distances to the top plane 43 and the central axis plane 5 are all designed as in the first embodiment. The configuration of the connecting pins 31 is also the same as in the first embodiment The cutting chain 59 shown in FIGS. 24 to 26 differs from the cutting chain 9 that is has a greater number of second connecting links 40. This makes cutting chain 59 more cost effective than cutting chain 9. In operation, however, cutting chain 59 suffers a clearly higher level of wear than cutting chain 9. Identical elements are indicated by means of the reference numerals used in the preceding drawings

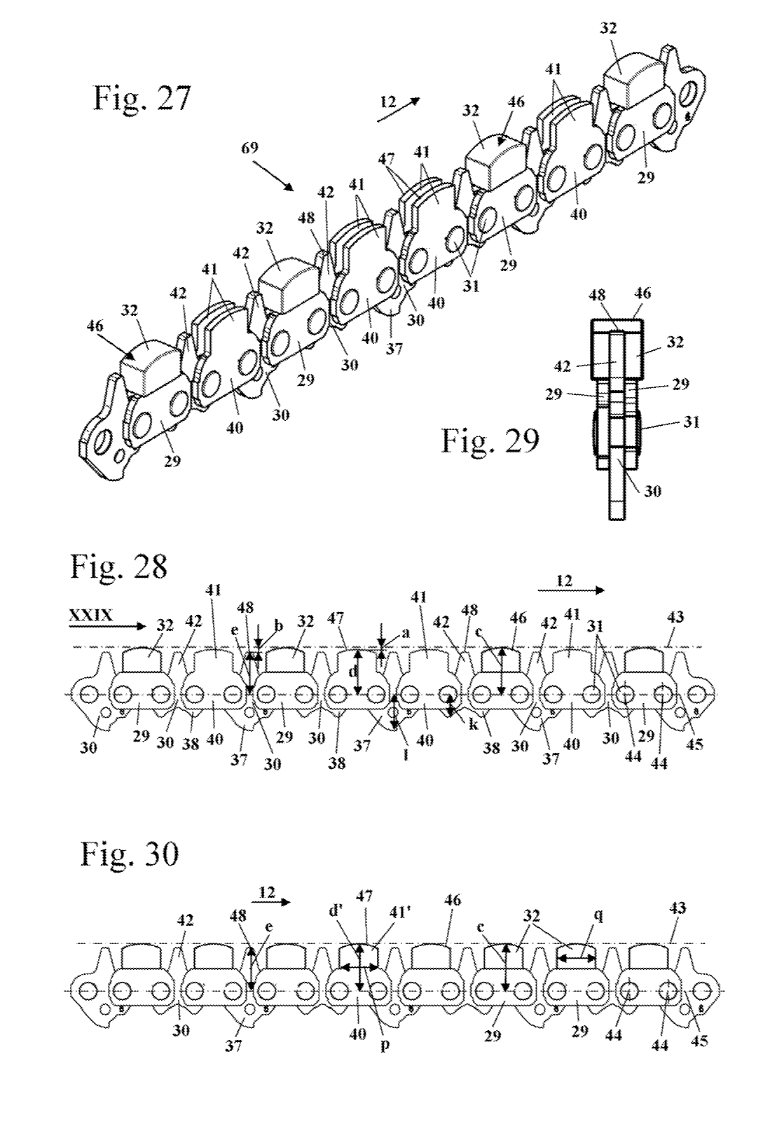

FIGS. 27 to 29 show a cutting chain 69 in which two second connecting links 40 and one second connecting link 40 are separated from a first connecting link 29 alternately in the direction of travel 12 of the cutting chain 69. As a result, more than half the connecting links in the cutting chain 69 are second connecting links 40. The first connecting links 29 and the second connecting links 40 can also be arranged irregularly in the direction of travel 12 of the cutting chain 69. In the cutting chain 69 shown in FIGS. 27 to 29 each drive link 30 also carries a projection 42. The distances between the tops of the cutting elements 30, supporting sections 41 and projections 42 shown in FIG. 38 are the same as the distances described in reference to the first embodiment.

FIG. 30 shows a cutting chain 79 which is essentially the same as the cutting chain 9 shown in FIG. 6. Identical reference numbers are used to indicate elements which are the same. The cutting chain 79 has first connecting links 29 which are each connected to a cutting element 32. The cutting chain 79 also has two second connecting links 40 positioned adjacent to one another at right angles to the direction of travel 12 which are designed separate from one another. The two second connecting links 40, which lie congruent to one another in the side view shown in FIG. 30, each have a supporting section 41′. The supporting section 41′ projects into the area provided between leading and trailing cutting elements 32. The supporting section 41′ is of the same height as the cutting elements 32. The area of the top 47 of the supporting section 41 furthest from the central axis plane 45 is spaced at a distance d′ from the central axis plane 45. Distance d′ is the same size as the distance c between the top 46 of the cutting element 32 and the central axis plane 45. The supporting section 41′ has length p measured in the direction of travel 12 which is the same as the length q of the cutting element 32 measured in the same direction.

The specification incorporates by reference the entire disclosure of German priority document 10 2012 010 978.4 having a filing date of May 31, 2012.

While specific embodiments of the invention have been shown and described in detail to illustrate the inventive principles, it will be understood that the invention may be embodied otherwise without departing from such principles.

What is claimed is:

1. A cutting chain for cutting mineral and metal materials, the cutting chain comprising:
central chain links;
lateral connecting links connecting the central chain links to each other, wherein at least two connecting links are positioned adjacent to each another, respectively, in a transverse direction relative to a direction of travel of the cutting chain;
connecting pins connecting the central chain links to the connecting links;
the connecting pins projecting through first openings in the connecting links and through second openings in the central chain links;
the connecting pins each having a central axis, wherein the central axes of the connecting pins are lying in a common central axis plane when the cutting chain is extended;
the connecting links including at least one first connecting link having a cutting element fixed thereto, the cutting element having a top facing away from the connecting pin;
the connecting links including at least one second connecting link having a supporting section instead of a cutting element;
the connecting pins each having a central section positioned between adjacent connecting links, wherein a diameter of the central section of the connecting pins is larger than the diameter of the first opening; and
at least two second connecting links positioned adjacent to one another in the transverse direction relative to the direction of travel are configured separate from each other.

2. The cutting chain according to claim 1, wherein two of the at least one first connecting link positioned adjacent to one another in the transverse direction are connected to one another by a common cutting element.

3. The cutting chain according to claim 1, wherein all of the connecting links are first connecting links or second connecting links.

4. The cutting chain according to claim 1, wherein at least one third of he connecting links are second connecting links.

5. The cutting chain according to claim 1 wherein a top of the supporting section, viewed in a direction of the central axis of the connecting pins, has a first contour and the top of the cutting element, viewed in the direction of the central axis of the connecting pins, has a second contour, wherein the first and second contours are identical.

6. The cutting chain according to claim 1 wherein the supporting section, viewed in a direction of the central axis of the connecting pins, has a contour that is approximately identical to a contour of the cutting element, viewed in the direction of the central axis of the connecting pins.

7. The cutting chain according to claim 1 wherein an area of the top of the cutting element spaced farthest from the central axis plane is positioned at a first distance from the central axis plane and an area of the supporting section farthest from the central axis plane is positioned at a second distance from the central axis plane, wherein the second distance is at least 50% of the first distance.

8. The cutting chain according to claim 7, wherein at least one of the central chain links has a projection.

9. The cutting chain according to claim 7, wherein the central chain links each have a projection.

10. The cutting chain according to claim 9, wherein the area of a top of the projection farthest away from the central axis plane is spaced at a third distance from the central axis plane, wherein the third distance is smaller than the first distance.

11. The cutting chain according to claim 10, wherein the third distance is smaller than the second distance.

12. The cutting chain according to claim 1, wherein at least one of the central chain links has a projection.

13. The cutting chain according to claim 1, wherein the central chain links each have a projection.

14. The cutting chain according to claim 1, wherein the supporting section has a first length measured in the direction of travel and the cutting element has a second length measured in the direction of travel, wherein the first length is at least approximately 50% of the second length.

15. The cutting chain according to claim 1, wherein the central chain links are drive links and wherein at least one of the drive links has a drive tooth for driving the cutting chain.

16. The cutting chain according to claim 15, wherein at least one of the drive links has a guide for engaging in a guide groove of a guide bar.

17. The cutting chain according to claim 16, wherein a distance relative to the central axis plane of an area of the guide farthest from the central axis plane is no more than 90% of a distance relative to the central axis plane of an area of the drive tooth farthest from the central axis plane.
